(19) United States
(12) Patent Application Publication
(10) Pub. No.: US 2010/0100423 A1
(43) Pub. Date: Apr. 22, 2010

(54) Picture your prize / bodagle marketing method

(76) Inventor: Thomas Michael Zima, Garden Grove, CA (US)

Correspondence Address: Thomas Michael Zima, 10532 Barbette Ave., Garden Grove, CA, 92843, US

(21) Appl. No.: 12/454,869

(22) Filed: May 26, 2009

Related U.S. Application Data
(60) Provisional application No. 61/128,745, filed on May 24, 2008.

(51) Int. Cl. G06Q 30/00; G06Q 10/00; G06Q 50/00

(52) U.S. Cl. 705/10; 705/14.43; 705/14.52; 705/14.68; 705/14.7

(57) ABSTRACT

The Picture Your Prize/Bodagle Marketing Method herein known as Bodagle, incorporates advertising into a fun and interactive game of chance. As users play the game their movements throughout the game board are tracked and categorized into a demographic profile. Unlike traditional games of chance where the winning prize is pre-determined, Bodagle users are allowed to make a choice from an array of products and services which they would most like to win. Users must scroll over the pictures of products or services within the game board in order to identify those products and services. The identification of those products and services appears in the product viewing screen and is tracked by Bodagle. Bodagle reports to advertisers eyeball time. Eyeball time is the amount of time a product or service appears in the product viewing screen.

The advantages to advertisers are that Bodagle offers a unique platform to advertise a product or service. Bodagle also offers advertisers a connection to this real time unbiased market research that users are unknowingly providing.

Because Bodagle can advertise a virtually limitless amount of products and services through multiple game boards, every consumer demographic can be reached. As users play multiple game boards's advertisers can gain an insight into those users potential buying habits.

Bodagle takes users through a unique advertising platform that evolves and enhances the value exchange between consumers and advertisers.

### CROSS-REFERENCE

This application relies for priority on the previously filed and presently pending U.S. Provisional Application Ser. No. 61/128,745, filed May 24, 2008; the entire disclosures of which are incorporated herein by this reference.

### BACKGROUND OF THE INVENTION

Internet advertising typically consists of banner ad or impression placement on the pages of an Internet website. These impressions are generally located near the top of the page as well as at the sides and bottom of pages. An impression consists of an advertisement that is displayed on each page that the user or visitor of that webpage might view. Banner advertising typically consists of a product description so the user can determine whether they want to further investigate that product. Banner advertising that currently exists on the Internet is largely ignored.

Contests with a prize give away, whereas a prize or service is given away, consist of a designated prize or service for that give away. Example: A person enters a contest to win a laptop computer. The contest sponsor, indicates that the computer to be won or given away will be a Dell model 1650. The Dell model 1650 is the prize available to the entrant. The person who enters qualifies for the contest by submitting the criteria of the sponsor requirements. Criteria requirements might be name, address, and some personal information.

Sponsor's use this personal information for market research and marketing strategies to market their products or services to consumers.

The Picture Your Prize/Bodagle Marketing Method ensures that users will in fact investigate the advertising. In fact, the Picture Your Prize/Bodagle Marketing Method is entirely advertising that doesn't look like advertising. Picture Your Prize/Bodagle is a complete marketing method that navigates users through the system in the form of a game or contest.

### SUMMARY OF THE INVENTION

In order to aid in the understanding of this invention it can be stated that this invention is advertising that doesn't look like advertising. This invention looks like a game. Users will investigate the advertising within this method.

The Picture Your Prize/Bodagle Marketing Meeting can guarantee to advertisers that their products will be viewed. Users/viewers will view advertising that they typically would ignore, yet the user might not even realize they are viewing advertising.

Because the Picture Your Prize/Bodagle Marketing Method does not identify through verbiage or sound the products or services on the game board, the user must scroll over those pictures in order to identify the products or services.

As the user scrolls over the pictures on the Picture Your Prize/Bodagle game board the product description, product information, product advertising, appears in the viewing screen at the top left hand corner of the game board.

When these products or services appear in the viewing screen on the top left corner of the game board, the Picture Your Prize/Bodagle Marketing Method captures that information of that user in regards to when that user scrolled over a specific product (exact time and date).

When these products or services appear in the screen on the top left corner of the game board, the Picture Your Prize/Bodagle Marketing Method captures that information of that user in regards to when that user scrolled over a specific product (the exact amount of time the user looked at that product description or advertising of the specific scrolled over product).

When these products or services appear in the viewing screen on the top left corner of the game board, the Picture Your Prize/Bodagle Marketing Method captures that information of that user in regards to when that user scrolled over a specific product (reports the information to the advertiser of how often, for how long, and what demographic viewed the advertising of that product or service within the Picture Your Prize/Bodagle Marketing Method game board).

The Picture Your Prize/Bodagle market research that is gathered in real time is unbiased and expresses the desires of the user/viewer, because users/viewers believe they are participating in a game of chance and not in a survey. The Picture Your Prize/Bodagle Marketing Method gathers the users/viewers movement throughout the advertising board and categorizes that data.

Whereas contests with a prize or give away offer a specific prize or service for that give away, this invention lets the participant choose the prize or service they wish to win if they should win the contest or give away. The user makes the choice of the prize or service they wish to win.

It is a purpose and advantage of this invention to ensure advertising impressions are viewed.

Another purpose and advantage of this invention is to ensure that advertising is paid attention to.

Another purpose and advantage of this invention is to report demographic and market research information specific to the amount of time a user's/viewer's eyeball was attached or looking at the advertising. This is called eyeball time. Eyeball time is the amount of time a viewer actually looked or scrolled over the pictures, not clicked on it, just looked at it.

Another purpose and advantage of this invention is to ensure that users will view typically, but not limited to, fifteen (15) to thirty (30) second commercials, about the products they have chosen within the Picture Your Prize/Bodagle Marketing Method advertising game board.

Another purpose and advantage of this invention is that an advertiser's typical, but not limited to, 15 to 30 second spots that air must be watched in their entirety, and cannot be X'd out of.

Another purpose and advantage of this invention is to actually be able to determine the desires of users while users navigate the Picture Your Prize/Bodagle game board. To tabulate these desires and determine potential buying habits and then target specific game boards to those individuals enhancing and evolving the value exchange between consumers and manufacturers.

Another purpose and advantage of this invention is to ensure that commercial advertising is targeted to specific users. To target those users with multiple (differently designed) commercials about the same product. Example: when a user plays the Picture Your Prize/Bodagle game board, the system keeps track of the commercials the user viewed and inserts different commercials in a rotation regarding the same product, therefore giving advertisers the advantage of more airtime with that user providing more information about their product and/or service. The Picture Your Prize/Bodagle game board is addressable advertising.

Another purpose and advantage of this invention is that commercial advertising cannot be TiVo'd out or blocked by browser settings.

Another purpose and advantage of this invention is that advertisers may take a section of a category herein known as square. Categories are Grand Prize, First Prize, Second Prize, Third Prize, Fourth Prize, and Fifth Prize. A category square is a section or a picture within a prize category. In this case there are five (5) squares within the Grand Prize category. Advertisers may advertise in one, two, three, four, or all five squares within a category.

Another purpose and advantage of this invention is the game board can display a virtually unlimited amount of advertising squares through multiple game boards.

Another purpose and advantage of this invention is that advertising costs can be dramatically reduced whereas an advertiser can advertise in one square of the Picture Your Prize/Bodagle game board category instead of the traditional advertiser's purchase of an entire banner advertising that currently exists.

Another purpose and advantage of this invention is manufacturers and advertisers can air a tutorial/infomercial about their product or service.

Another purpose and advantage of this invention is that multiple advertisers may advertise in the same prize category.

Another purpose and advantage of this invention is that all prize categories, whether it is Grand Prize or Fifth Prize, will get equal attention.

Another purpose and advantage of this invention is that each category and category square will draw attention to each other.

### BRIEF DESCRIPTION OF THE DRAWINGS

FIG. 1 is a perspective view of the Picture Your Prize/Bodagle Marketing Method game board in the not signed in position. The board consists of, but is not limited to, thirty (30) advertising squares within six categories (Grand Prize, First Prize, Second Prize, Third Prize, Fourth Prize, and Fifth Prize). A product viewing screen located in the top left corner explains to users how to play the game. The right side of the game board lists a section of past winners which displays pictures and descriptions of the prizes previously won, and the people who won them. This Past Winners section displays five or more past winners vertically along the right side of the game board. This section rotates as a rotunda. This display changes approximately every 10 seconds so as to continually display numerous past winners and the products that were won.

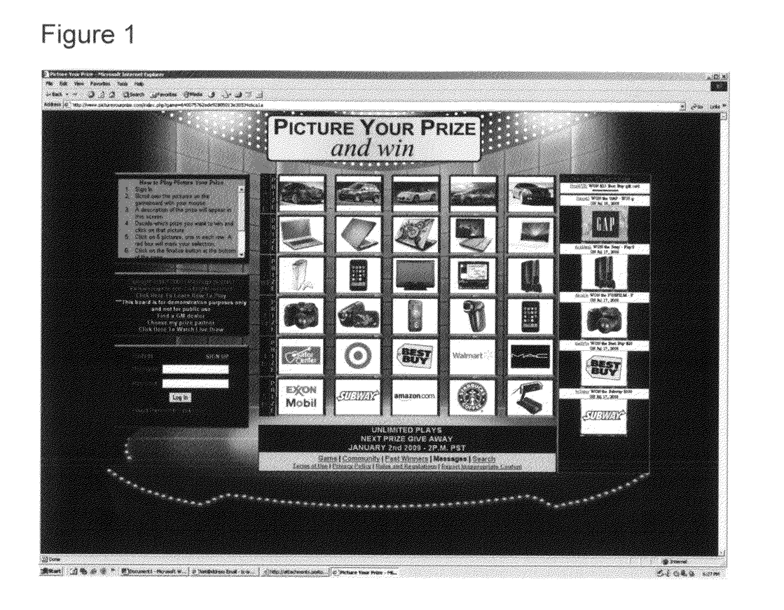

FIG. 2 is a similar view as FIG. 1 whereas the user has scrolled over a picture and an advertisement appears in the product viewing screen at the top/left of game board. Note Apple iPod touch in the product viewing screen. This indicates that the curser would be positioned over that picture of the Apple iPod on the game board.

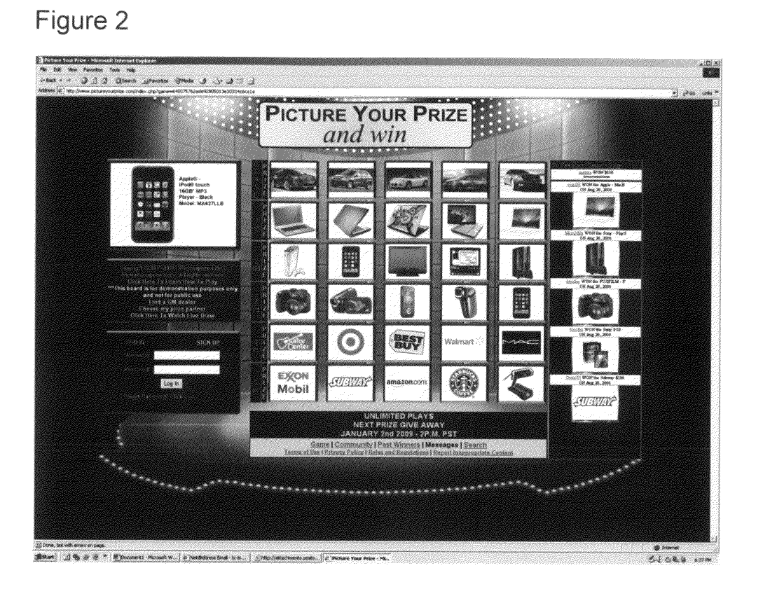

FIG. 3 is a similar view as FIG. 1 and FIG. 2 showing a commercial pop out that airs a typically, but not limited to, 15 to 30 second commercial about a product that was scrolled over and clicked on within the game board. In this case the commercial is a Chevy Malibu car commercial. Please note: the pop out commercial dominates the center of the game board. Please note: the words at the bottom of the pop out commercial “So you may play, please Sign up or Login.”

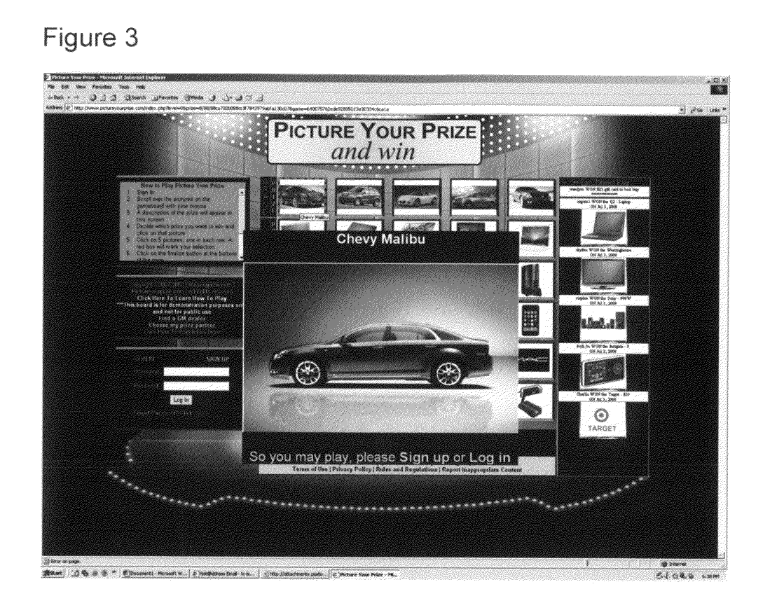

FIG. 4 is a similar view as FIG. 1 and FIG. 2 showing a user signing in the “SIGN IN” section in the bottom left of game board. Note username zman.

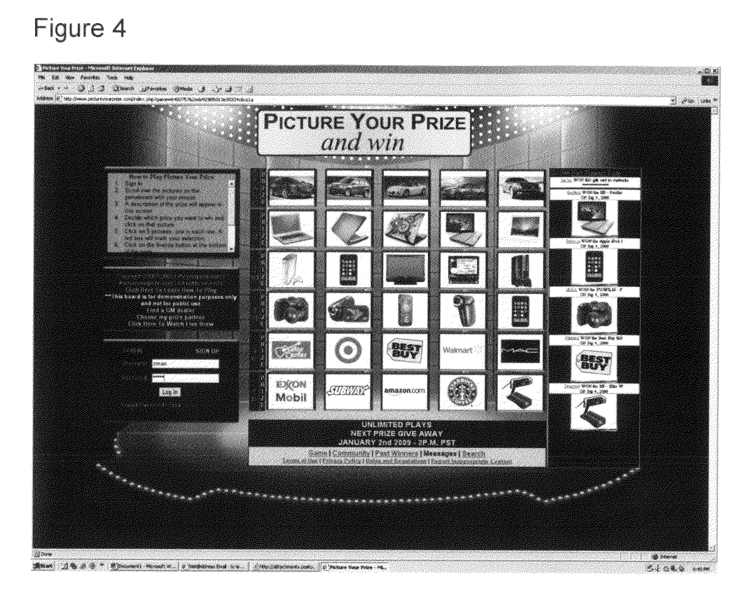

FIG. 5 is a similar view as FIG. 3 and FIG. 4 with the user signed in to the game board. Note left bottom of game board prize categories now appear for the user: Grand Prize, First Prize, Second Prize, Third Prize, Fourth Prize, Fifth Prize. Note the “My past selections” link or button located at extreme bottom left of game board

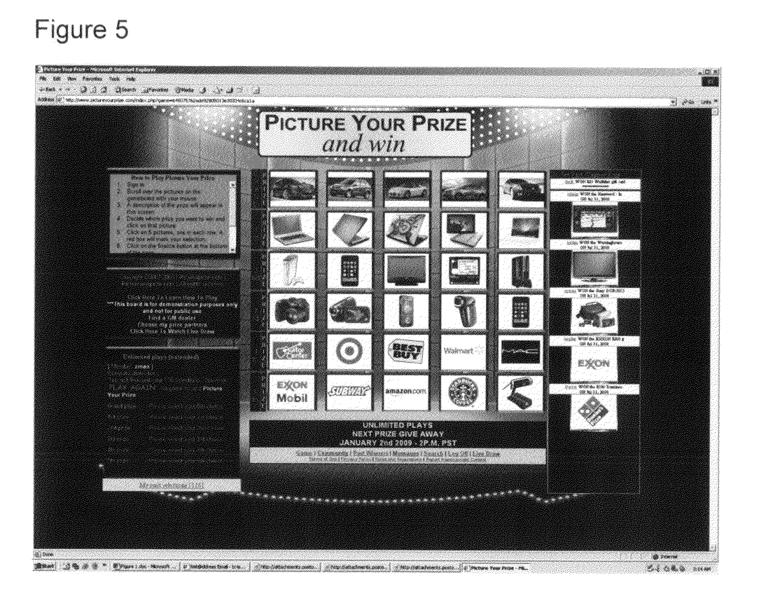

FIG. 6 is a similar view of FIG. 5 with the curser placed on the first car in the Grand Prize category. With the picture and description of that prize appearing in the product viewing screen in the top left corner of the game board.

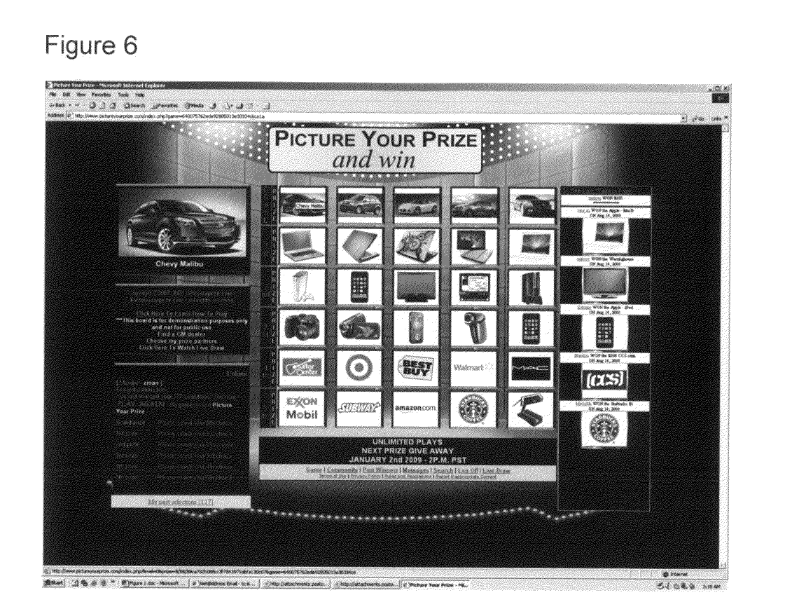

FIG. 7 is a similar view of FIG. 5 and FIG. 6 indicating the choice the user has made by clicking on the first picture in the Grand Prize category, in this case the Chevy Malibu. A Pop Out commercial about the product the Chevy Malibu dominates the center of the game board and airs for its designated time.

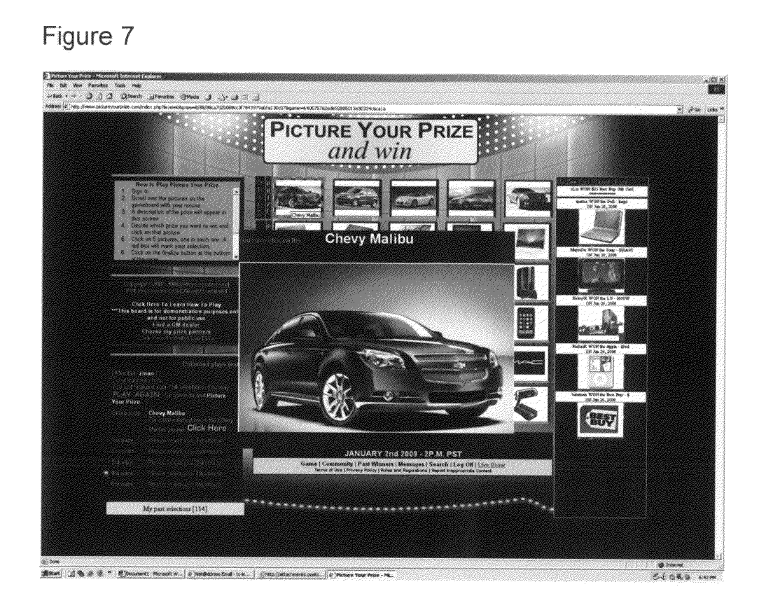

FIG. 8 is a similar view of FIG. 7 showing the commercial pop out finished and the first picture in the Grand Prize category encircled in a dashed red box indicating the users choice of the prize they have selected to win if they should win within that category, in this case the Chevy Malibu. Please note the bottom left section Grand Prize category now displays the words Chevy Malibu, as well as “For more information on the Chevy Malibu please Click Here.”

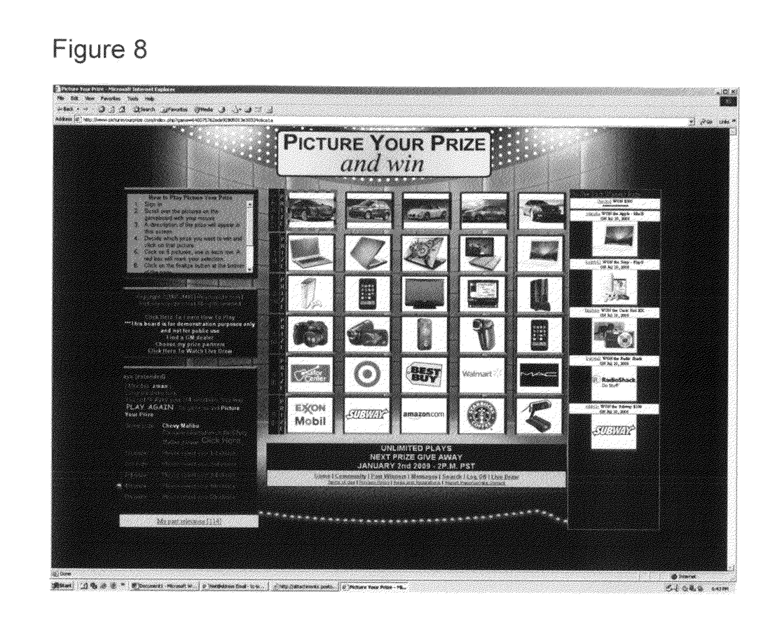

FIG. 9 is a similar view to FIG. 8, showing a pop out tutorial infomercial about the product that dominates the center of the game board, in this case Chevy Malibu. The pop out tutorial/infomercial is initiated by clicking on the “Click Here” link or button located in the Grand Prize description in the bottom left section of the screen Grand Prize category Chevy Malibu for more information on the Chevy Malibu please “Click Here.” Please note on the pop out tutorial/infomercial the words to go “To the Chevy Malibu's website, please Click Here. That “Click Here” link or button will navigate the user to the manufacturer/advertiser website, in this case the Chevy Malibu.

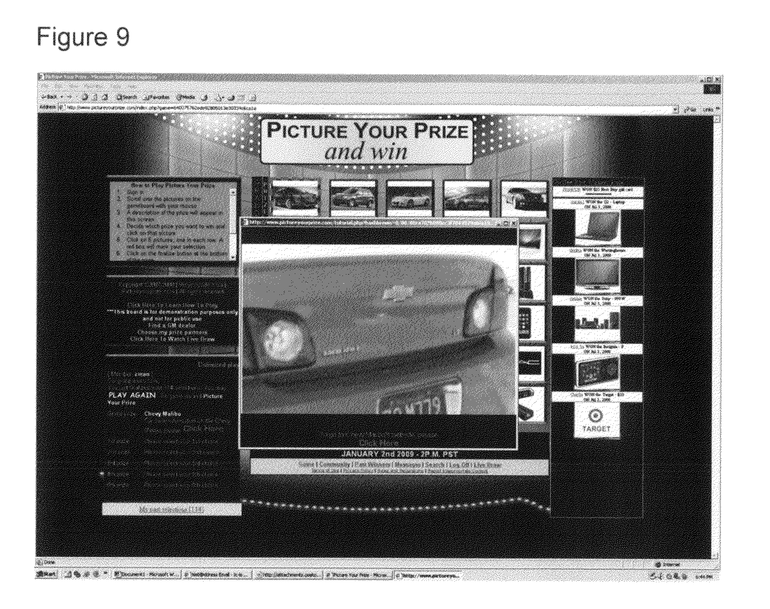

FIG. 10 is a similar view to FIG. 8 with the first advertising square in the Grand Prize category selected and encircled in a dashed red box. The first advertising square is encircled in a dashed red box in the First Prize category, the second advertising square is encircled in a dashed red box in the second prize category, the fourth advertising square is encircled in a dashed red box in the third prize category, the third advertising square is encircled in a dashed red box in the fourth prize category, and the fourth advertising square is encircled in a dashed red box in the fifth prize category. These boxes encircled with a red dashed box indicate the choices the user has made within each category of the prizes or products they wish to win, if they should in fact win within any category. Please note the white link or button located on the bottom left of the game board under the written descriptions of prizes chosen with the word “Finalize.” The Finalize link or button will confirm and finalize the user's selections returning the game board position similar to FIG. 5.

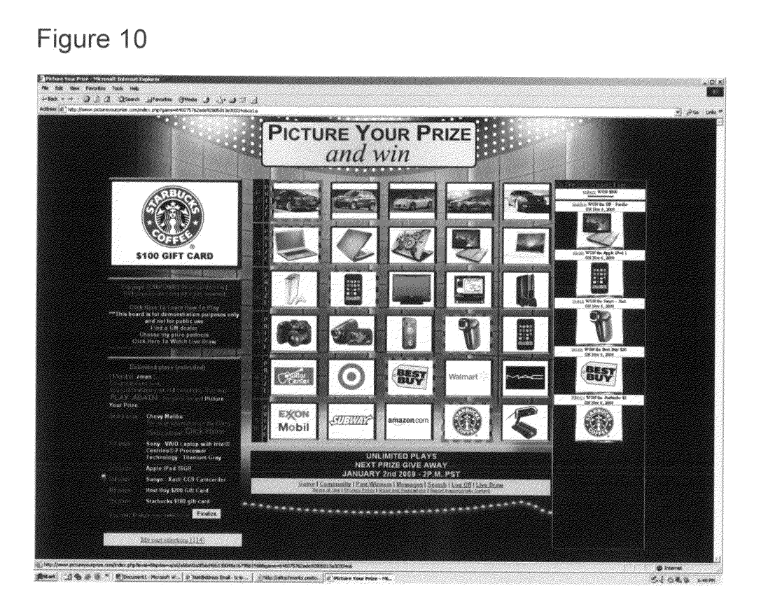

FIG. 11 is a is a perspective view of the Picture Your Prize/Bodagle Marketing Method game board indicating the users past selections in previous game board finalizations, showing the entry registration number and the exact time and date the entry was made and the products they chose for Grand Prize, First Prize, Second Prize, Third Prize, Fourth Prize, Fifth Prize displayed laterally in that order.

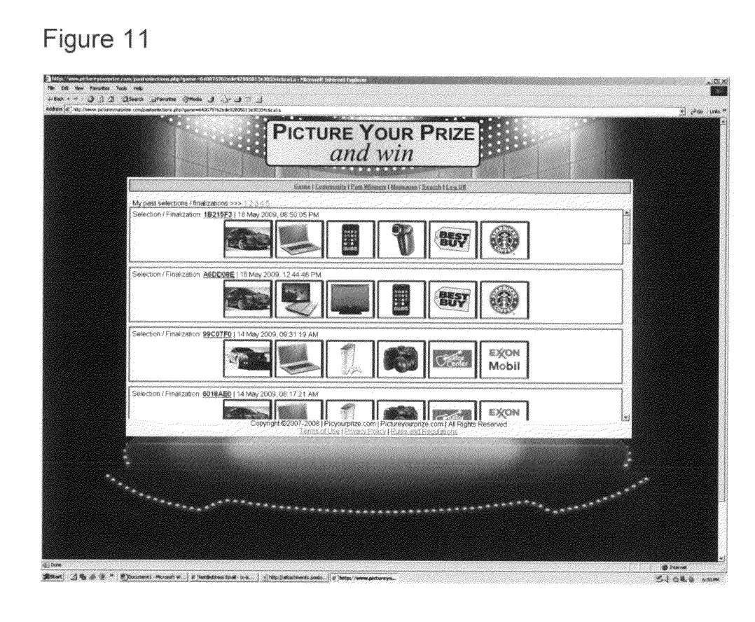

FIG. 12 is a perspective view of the Picture Your Prize/Bodagle Marketing Method game board past winners page. This page is accessed by clicking on the past winners link or button located at the extreme top right in FIGS. 1 through 10 This figure shows previous prizes won, with pictures of the individuals/persons who won those prizes.

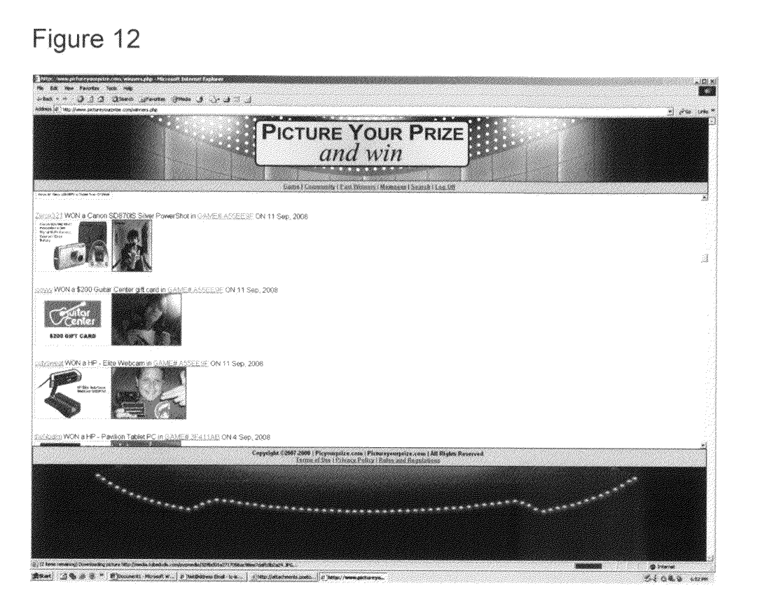

What is claimed is:

1. The Picture Your Prize/Bodagle Marketing Method can determine how long someone's eyeball was attached to the advertising displayed within the product viewing screen or was viewing the advertising displayed within the game board (eyeball time).

2. The Picture Your Prize/Bodagle Marketing Method ensures the user will watch the advertising displayed on the Picture Your Prize/Bodagle Marketing Method game board.

3. The Picture Your Prize/Bodagle Marketing Method gathers in real time marketing and marketing survey information as users play or navigate the game board.

4. The Picture Your Prize/Bodagle Marketing Method gathers unbiased marketing and survey information because the user is unaware that their movements and selections are categorized into marketing segment information.

5. The Picture Your Prize/Bodagle Marketing Method evolves and enhances the value exchange between consumers and advertisers by ensuring consumers will view their advertising.

6. The Picture Your Prize/Bodagle Marketing Method is advertising that doesn't look like advertising because it is presented in the format of a game.

7. The Picture Your Prize/Bodagle Marketing Method allows users to choose the prize and/or item that they want to win in each category rather than being told what prize they will win.

8. The Picture Your Prize/Bodagle Marketing Method allows advertisers/manufacturers to purchase a single advertising square from a prize category, greatly reducing the cost to them for advertising.

9. The Picture Your Prize/Bodagle Marketing Method reports eyeball time to advertisers and manufacturers in real time.

10. The Picture Your Prize/Bodagle Marketing Method allows users to choose the products or services they wish to win rather than having to accept a predetermined prize.

11. Users interact with advertising.

12. The Picture Your Prize/Bodagle Marketing Method is an addressable advertising platform.

13. The Picture Your Prize/Bodagle Marketing Method Rotates commercial advertising specific to the user and determines what commercials target the proper demographic.

14. The Picture Your Prize/Bodagle Marketing Method can automatically play a fresh or different commercial than last viewed by a user for that product or service.

15. The Picture your Prize/Bodagle Marketing Method provides an unlimited advertising platform through multiple game boards.

16. The Picture Your Prize/Bodagle Marketing Method cannot be blocked by TEVO or browser settings.

17. The Picture Your Prize/Bodagle creates a segment of internet advertising between banner impression and click through to advertisers website.

18. The Picture Your Prize/Bodagle Marketing Method is an advertising game.

19. The Picture Your Prize/Bodagle Marketing Method is a Game Show.

20. The Picture Your Prize/Bodagle Marketing Method makes advertising a social environment.
